(19) United States
(12) Patent Application Publication
(10) Pub. No.: US 2009/0204528 A1
(43) Pub. Date: Aug. 13, 2009

(54) SYSTEM AND METHOD FOR FACILITATING PURCHASE OF FINANCIAL INVESTMENTS ON BEHALF OF A BENEFICIARY AND PROVIDING INTERACTIVE INVESTMENT INFORMATION

(76) Inventor: Amy Rose Moses, New York, NY (US)

Correspondence Address: MOORE & VAN ALLEN PLLC, P.O. BOX 13706, Research Triangle Park, NC, 27709, US

(21) Appl. No.: 12/246,387

(22) Filed: Oct. 6, 2008

Related U.S. Application Data
(60) Provisional application No. 60/977,443, filed on Oct. 4, 2007.

(51) Int. Cl. G06Q 40/00

(52) U.S. Cl. 705/35

(57) ABSTRACT

A system, method and software for facilitating the purchase of financial investments for the benefit of beneficiary and providing educational and entertaining interactive tools regarding same is disclosed. The system includes at least one database containing information regarding one or more financial instruments. The system further includes at least one first user interface to enable a first user to access information regarding one or more financial investments, to facilitate the purchase by the first user of one or more financial investments, and to enable the first user to designate a second user beneficiary of the financial investment. The system also includes at least one second user interface that at a minimum provides information to the second user beneficiary regarding the financial investment. The system may also allow a first user to plan events and invite third users to such events and inform third users of opportunities to purchase investments for the benefit of the second user beneficiary.

### CROSS REFERENCE TO RELATED REFERENCE

The present invention claims priority to U.S. Provisional Patent Application No. 60/977,443, filed on Oct. 4, 2007 entitled Ballooning Nest Eggs, the contents of which are incorporated herein by reference.

### BACKGROUND OF THE INVENTION

1. Field of the Invention

The present invention relates generally to investment services and, in particular, the application of such services over a network, such as the Internet.

2. Description of the Related Prior Art

Currently, there are numerous opportunities to purchase financial investments. One significant area of financial investment is that of intergenerational investing, i.e. investing by one generation for the benefit of the second or third generation. At present, when one generation (adults) purchases financial investments for the benefit of a younger generation (children), those recipients of financial gift receive little or no notice of such purchases or any kind of gift experience or child-focused communications relating to that investment. Further, there is at present no system that provides the recipient of such a financial investment with ongoing engaging and entertaining opportunities that relate to that gift and the broader financial marketplace. In addition, at present there is no system that enables the purchaser of such a financial investment to remain in contact with the recipient via a network, such as the Internet, regarding the growth of, new contributions to and the management of such a financial investment. Conversely, there is at present no system or method that enables the recipient of the financial investment to remain in contact with the donor regarding the investment. For the parents and grandparents who open up investment accounts for their kids or grandkids, currently there is no system that connects the actual purchase of investments for kids to planning parties and other events relating to those gift-giving occasions and facilitates planning those parties.

In addition to the above needs, there are also needs for facilitating other parties to participate in investing for a selected beneficiary. Specifically, many parents and close family see the need to rethink traditional forms of gift giving and steer their friends and family towards buying more meaningful long-term gifts, such as a financial investment, that will benefit those children (e.g., by helping secure their financial future) while at the same time pleasing those kids through offering a gift experience that will delight the young gift recipients. For example, many parents and grandparents see the need to redirect many of the gifts given to children and grandchildren for holidays and birthdays away from toys, electronic games or other objects to financial investment gifts that will benefit the child far into the future. At this stage, there are no ready tools to encourage gift givers to choose such investment gifts over more traditional object-type gifts because current investment gift options do not offer any compelling gift experience for the kids or the gifter and or an enticing and simple method by which to give such a gift. In fact, investment gift options have barely changed over the last number of decades.

Accordingly, there is a need for a user interface-driven system that would allow a first user to perform research and connect to various resources for the purchase of investments for the benefit of a second user beneficiary. Systems are also needed to allow the first user to provide third users information regarding potential gift-giving opportunities for the benefit of the second user beneficiary, such as announcements of major events, such as birthdays, graduations, holidays, parties, etc. Further, systems are needed that allow for tracking and providing information to some or all users regarding investments that have been made on behalf of a second party beneficiary user. Systems are also needed to provide investment education to all users and especially, the second user beneficiary, such as participation in varied levels of educational and entertainment opportunities within the system relating to financial and other kinds of investing.

### BRIEF SUMMARY OF THE INVENTION

The present invention facilitates the purchase of financial investments on behalf of a beneficiary, a child, and providing information regarding financial and other kinds of investing. The system includes at least one database comprising information regarding one or more financial investments. The system also includes at least one first user interface, likely a parent or grandparent, to provide information to a first user regarding one or more financial investments, to facilitate the purchase by the first user of one or more financial investments, and to designate a second user as either a beneficiary or owner of the financial investment. The system further includes at least one second user interface to provide information to a second user regarding the financial investment, whereby the second user can obtain information regarding the financial investment.

The present invention also provides for a computer implemented method for facilitating the purchase of financial investments on behalf of a beneficiary and providing information regarding investing. The method includes providing at least one database, the database comprising information regarding one or more financial investments. The method also includes providing at least one first user interface to provide information to a first user regarding one or more financial investments, to facilitate the purchase by the first user of one or more financial investments, and to designate a second user as either a beneficiary or owner of the financial investment. The method further includes providing at least one second user interface to provide information to a second user regarding the financial investment, whereby the second user can obtain information regarding the financial investment.

In addition to providing systems and methods for facilitating the purchase of investments on behalf of a young beneficiary, embodiments of the present invention may also provide various educational information regarding those investments, specifically, and the broader investment marketplace, in general. The systems and methods may provide interactive tools to provide information to the beneficiary regarding the investment. For those beneficiaries and other non-beneficiary children who visit the second user interface, the systems and methods may provide interactive tools for all types of real-life investments (e.g., financial, real estate, stamps), marketplace developments, and other investing-themed educational information, all of which will be presented in a way that entertains and engages those children.

Embodiments of the invention may also allow for the creation of a user account in the database. The user account is typically created by the first user for the benefit of the second user. The user account may be used to track investments made on behalf of the second user beneficiary. It may also be used to collect money from third users, such as friends and family who make gift donations, which the first user can use to purchase more investments on behalf of the second user beneficiary and manage such investments through the user account. The first user may select various control features to determine which user has control of certain features of the account. For example, the first user may set up the account so that the first user controls the investments made for the benefit of the second user beneficiary. The user account may also contain various personal information regarding the first and/or second user. The user account may be used by the first user, the second user or even a third user to create and manage an event for the benefit for the beneficiary. For example, a user could plan a birthday party for a child or grandchild via the invention and send out invitations and other party related information to third parties. The systems and methods of the invention may facilitate allowing such third parties to purchase investments for the beneficiary as gifts for such event.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

The invention will now be described with reference to the accompanying drawings which illustrate disclosed embodiments of the method of the present invention falling within the scope of the appended claims.

FIG. 1 is a block diagram illustrating a system environment in which the systems and methods of the present invention may be implemented;

FIG. 2 is flow chart of an example of a method for a system for facilitating the purchase of a financial investment, and providing educational and entertainment interactive tools to the investment beneficiary and other non-beneficiary children in accordance with an embodiment of the present invention;

FIG. 3 is a block schematic diagram of a system for facilitating the purchase of a financial investment, and providing educational and entertainment interactive tools to the investment beneficiary and other non-beneficiary children in accordance with an embodiment of the present invention;

FIG. 4 is an example of an investor interface for facilitating the purchase of a financial investment in accordance with an embodiment of the present invention; and

FIG. 5 is an example of a beneficiary interface for providing educational and entertainment interactive tools to the investment beneficiary in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

As a general overview, the present invention provides systems and methods that facilitate the purchase of investments by first- and third-users for the benefit of second user beneficiaries, typically children from birth to age 18. The systems and methods provide first and third user interfaces that provide various information on investing, in general, including various investment calculators, investment forums, possible chat rooms, etc. Essentially, in some embodiments, the first and third user interfaces are portals to aid users in all aspects of investment education, investment planning, gathering information from other users, collaborating with other users, etc. on behalf of their children or grandchildren. First users likely will be parents or grandparents who will set up the account on behalf of the second user beneficiaries; the third users can add to the account once it's set up (either by adding directly into the account through the financial representative, or sending money (electronically or via a check) to the first or second user with a customizable greeting card provided by the system.

In addition to providing investment education and tools, embodiments of the present invention may also facilitate the purchase of investments from financial advisors and institutions. For example, the first user interface may provide various links to financial advisors and institutions that offer investments. Typically, agreements are put in place with various financial advisors and institutions to allow for such links to be provided on the first user interface. In this regard, the systems and methods of the present invention may operate as a place of advertisement for such financial institutions. Further, the systems and methods of the present invention may facilitate lead generation for the benefit of such financial institutions.

At a basic level, the systems and methods of the present invention may allow users to link from the first user interface to a selected financial institution's website in order to view investment items or opportunities and potentially make purchases. In some more sophisticated embodiments, the first user interface may operate as a proxy for these financial institutions. In these embodiments, when a user activates a link associated with one or more of the financial institutions, the user believes that they are redirected to the selected financial institution; however, the user is actually navigating a proxy site controlled by the systems and methods of the present invention. This allows the systems and methods of the present invention to track the activities of the user as the user navigates various financial institution web sites. This information can be used for gathering statistical data, lead generation, etc. Such a proxy site may also be used to track investment purchases made by users from such financial institutions.

In general, the systems and methods of the present invention may not operate to perform investment transactions on behalf of a user, as these are highly regulated activities. As such, in some embodiments, the system and methods may provide links and other connections (e.g., phone numbers) to financial institutions to facilitate investment purchases. In other embodiments, the systems and methods may use proxy sites to facilitate investment purchases. It is understood that these are only two methods for facilitating of investment purchases. Other systems and methods that allow for a user to link or otherwise provided by proxy information from a financial institution in order to purchase investments are contemplated by the invention.

Once an investment has been purchased by first and third users, information regarding such purchase is communicated to the system. For example, where the first user is linked to a financial institution to make an investment purchase, information regarding the investment purchase is provided back to the system. The system may then track the investment, provide information to users associated with the investment, etc. If a proxy server system is used, the proxy server will communicate the purchase to the system for tracking.

In one embodiment, the system of the present invention operates as a portal allowing the first user to monitor, track, receive information, etc. regarding a purchased investment. The system allows the user to make further investments and facilitate the selling of the investment, etc. as discussed above. Typically, the system allows the first user to create a user account in a database to store information about the first and second user, as well as maintain data regarding investments made on behalf of the second user beneficiary. The first user may set controls on the user account, whereby the first user may control all aspects of the account or may provide some level of control to the second user beneficiary. For example, the first user may set of the user account, such that only the first user may make changes to the investments, invest dividends, invest monetary gifts provided by third users to the account, etc. In other embodiments, the first user may allow the second user beneficiary to have control over some of these functions. As described below, the user account may allow the first, second, or third users to plan events on behalf the second user, facilitate communication between all of the users, allow third users to provide monetary or investment gifts, etc.

As mentioned, embodiments of the present invention also facilitate the purchase of investments by a first or third user for the benefit of second user beneficiary. In this embodiment, the user is either linked or proxied to a financial institution to purchase an investment. During the transaction, the financial advisor or financial institution may facilitate designation of the second user beneficiary for the purchased investment. In this embodiment, information regarding the investment purchase and the beneficiary are transmitted to the system. In this embodiment, in addition to allowing the first user to track the investment, the system may also provide a second user interface for use by the second user beneficiary. Depending on the embodiment, the second user interface may provide various information, tools, education, games, etc. directed to the second user beneficiary.

For example, in some embodiments, the system may send the second user beneficiary a notice indicating that an investment has been purchased on the second user's behalf. The notice could be as simple as an email, text message, or the like, communications via the second user interface or it could be a personal mailing, a token gift announcing the purchase, etc. In addition to providing notice, in some embodiments, the system may allow the second user beneficiary via the second user interface to view the investment, possibly its value, track the investment, etc. In addition or in alternative embodiments, the system of the present invention may provide various educational tools, games, and other interactive media and financial market news and analysis to the second user beneficiary regarding investing, saving, and other financial information and education.

In addition to facilitating the purchase of investments by a first user for the benefit of a second user beneficiary, the systems and methods of the present invention may also provide various other tools. As mentioned, the system may provide various information on investing in general, various investment calculators, investment forums, possible chat rooms, etc. In addition, in some embodiments, the system of the present invention may allow either one or both the first user and the second user beneficiary to communicate with third users. For example, the system, via the first user interface, may allow a first user to plan parties or other events via the system and communicate such events to third parties. For example, a first user could plan a party for the second user beneficiary and send invitations to third parties with a link to the system's website to encourage such a purchase or financial contribution to the second users investment account. For example, the first user could alert third users that the first user has initiated an investment account for the second user beneficiary and invite the third users to contribute to the investment account.

The system of the present invention may also allow the second user beneficiary to similarly create events and invite third users with a link to the system's website. The second user could also invite third users to make contributions to the investment account. For example, if the second user beneficiary is graduating, the second user beneficiary could create a notice to third users of the events and also invite third users to make investment contributions as gifts.

In general, the systems and methods of the present invention provide an interface that facilitates investment information, learning tools, calculators, etc. for adults and children. The systems and methods also facilitate the purchase of investments, investment tracking, etc. The systems and methods allow users to purchase investments for the benefit of second user beneficiaries. Further, the systems and methods of the present invention allow users to plan events, invite third users, participate in forums, chat rooms, etc. In short, the systems and methods of the present invention in various embodiments provide an overall investor and gifter experience that extends beyond simply the transaction of buying financial instruments. More general information is provided in the summary section of the disclosure below.

The above description relates to creation and maintenance of investments by a first user for the benefit of a second user beneficiary. The system includes various investment information and tools, as well as educational information, games, event planning, etc. It is understood that access to these features of the system are not limited only to users who purchase investments. The systems and methods of the present invention may be accessed and used by various users to gain financial investment and educational information, plan kids and family parties and more. For example, the systems and methods may be used by users to research investments, obtain investment information, use investment tool, contact and/or chat with other users, plan events, etc. The systems and methods may also be used by children for educational purposes, play investment games, etc.

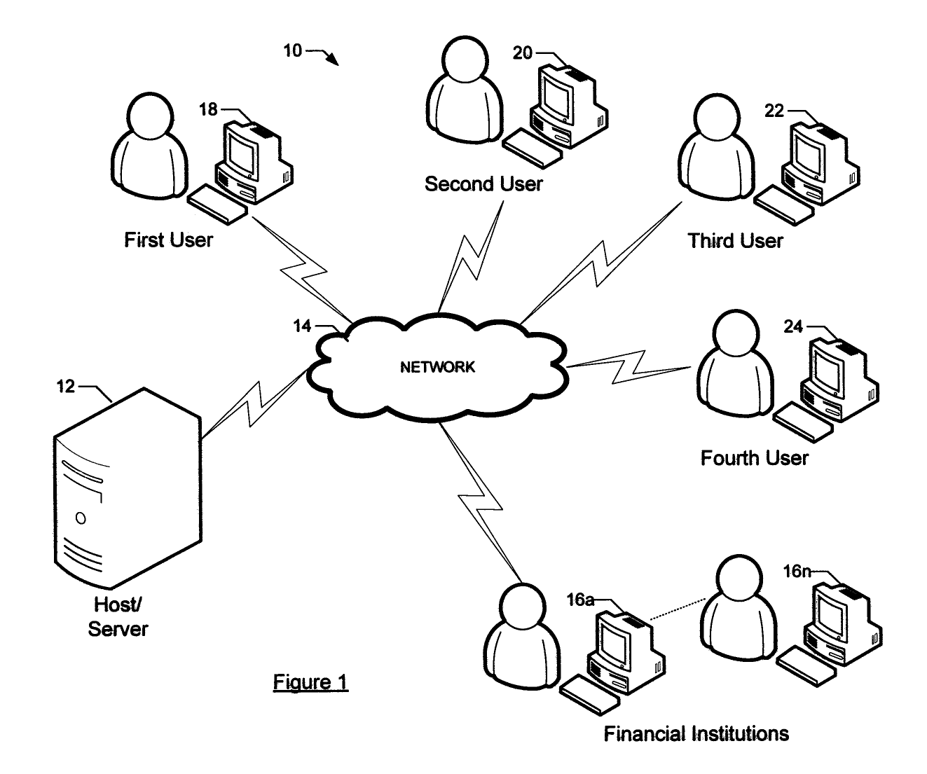

FIG. 1 illustrates briefly an environment 10 in which the present invention may be implemented. In particular, it illustrates a host/server 12 connected to a network 14 such as the Internet. The host/server 12 includes the various web page interfaces, content, software, rules engines, etc. for operating the systems, methods, and various interfaces of the present invention. Connected to the host/server 12 via the network are various financial systems 16a-16n, such as brokers, financial advisors, investment companies, financial institutions, etc. It is noted here that various portions of the specification refer to financial advisors and institutions for the purchase of investments. It must be understood that the system is capable of operating with any individual or entity offering investment products, real estate, etc.

Also connected via the network are various users 18, 20, 22, and 24 who interact with the system via various user interfaces. The user interfaces as used herein typically refers to web pages that are provided to a user via a user's PC, PDA, etc. It understood, however, that a user interface may be any software, hardware, web application, etc. that allows a user to interact with the system. There are generally four types of users accessing the system. A first user 18 generally sets up a user account for the benefit of a second user beneficiary 20. The first user accesses the system via the host/server 12 and views investment information, uses investment tools, etc. The first user 18 may set up an account on the system via the host/server 12 and via the host/server 12 access one or more of the various financial systems 16a-16n to purchase investments for the benefit of the second user beneficiary. The first user may also contact a participating financial advisor and institution to purchase an investment for a second user by phone or in person. Once that financial advisor or institution records that transaction in its system, that system will alert the network 14 and host server 12. Information regarding such investments is maintained in a database, along with user account information, in the host/server 12.

The second user beneficiary 20 may also access the system to view investment information made on the second user's behalf. The second user beneficiary 20 may also access the system to obtain investment educational information, play games, plan events, invite others to events (second and third users), chat with others, etc.

Third users 22 may be friends and family of the second user beneficiary who are invited or driven to the system by either the first or second user. The third users typically use the investment information, tools, chat rooms, etc. in the same way as the first users. The third users may make their own investments for the benefit of the second user beneficiary, in which case, information about such investments will be maintained for the second user beneficiary in the user account by the system. In other instances, the third user may give other monetary gifts (e.g., personal checks or cash) for the benefit of the second user beneficiary. Such monetary gifts are associated with the second user beneficiary by the user account. Depending on how the first user has configured control over the account either the first or second user may use the monetary gifts to make further investments for the benefit of the second user beneficiary.

Fourth users 24 may access the system not purchase investments for the benefit of the a second user beneficiary, but to gather investment information, use investment tools, access educational information, play games, plan invents, and/or facilitate purchase of investments for their own benefit. In other words, the systems and methods of the present invention may be accessed and used by users who are not necessarily purchasing investments or making monetary donations on behalf of a beneficiary or by young users who have not received an investment gift through the system.

As discussed above, the systems and methods of the present invention provide a platform to promote the sale of investments on behalf of the invention's financial partners, provide investment education, games, forums, chat rooms, event planning, etc. Provided below are example operations of the systems and methods of the present invention. It is understood that the description below is provided to explain example embodiments of the invention and that the invention should not be restricted by the below discussion.

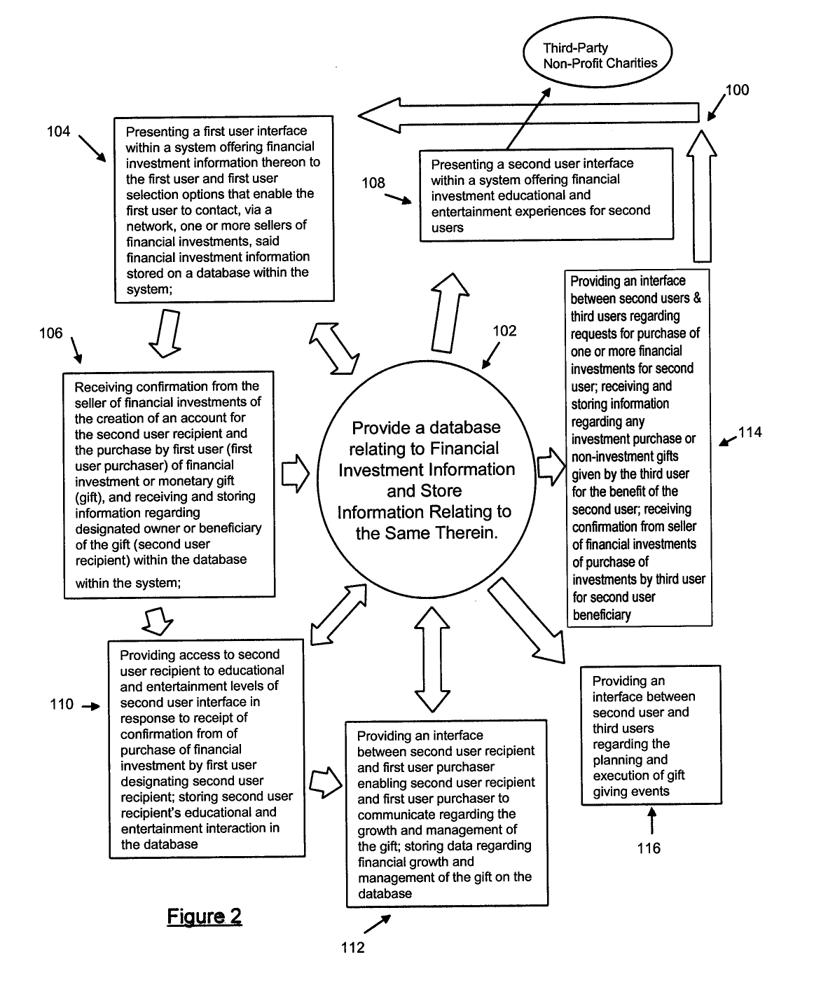

FIG. 2 is an operational diagram 100 of an example of the system and method for facilitating the purchase of a financial investment and providing information regarding the same. The diagram 100 illustrates some of the various steps and features of the present embodiment but the steps may be taken in many different ways and in different order depending on the situation. The following is an example of how the embodiment may operate in one situation. The first step 102 in the system is to provide a database containing financial investment information. The database would include information relating to various types of financial investments as well as the identifying one or more sellers of such financial investments.

Either this database or a separate database includes account information about users. For example, the database may include information regarding an account created by a first user for a second user beneficiary. In addition to financial and investment information associated with the user-created account, the database may include personal and event information such as the second user beneficiary's birthday and upcoming key events in that child's life, the birthdays or key events of the first and second users extended network of friends and family, etc. Essentially, the database could include any data associated with the first and second user as may be desired. The database could also include data input by third users, if appropriate.

The second step 104 is to present a first user interface within the system offering financial investment information to a first user. The first user interface provides first user selection options that enable the first user to obtain information regarding a variety of financial investments such as stocks, bonds, mutual funds, and the like. In some embodiments, the systems and methods of the present invention provide information and facilitate the purchase of investments for the benefit a second user beneficiary. In particular, the first user interface may be targeted toward potential adult investors who are interested in buying financial investments, such as contributions to a 529 account or another college saving plan, or other long term investments, for the benefit of their children, grandchildren or other young beneficiaries. The first user interface would provide details on the purchase of a financial investment and how to set up an account on the system. Information provided by the first user is received and stored on the database. The first user interface may also provide reasons for buying a financial investment (e.g. the importance of savings for a child's future), instructions and tools for the parents or other close relative(s) to set up a child's gift registry on the first user interface, tools for parents to communicate with friends and family about their child's account and any upcoming gift giving events, and tips and tools for planning and executing gift-giving events (this will include content provided by the system as well as peer-to-peer advise from other first users). The gift registry, communication and planning and executing gift giving events will be discussed in more detail below.

The first user interface enables the first user to contact, via a network link or phone, one or more sellers of such financial investments if the first user were interested in buying any such financial investments. The first user interface may also have information relating to charitable giving and non-profit groups that the first user may be interested in donating to on behalf of their children or other beneficiaries. The first user interface also enables the first user to identify the beneficiary of a financial investment or charitable donation. Such information is stored on a database within the system in a user account. The database also stores information regarding first users who have used the first user interface and who have contacted any sellers of financial investments or charitable/non-profit organizations identified on the database. The first user interface would also introduce first users to a second user interface. The second user interface is designed for children, the likely beneficiaries of first user investment purchases. The second user interface is designed to provide education and entertaining interactive tools relating to money, finance, savings, investment, giving and the like. The system also allows the second user to contact a third user and invite the third user to events, etc. The details of the second user interface are discussed below. The first user interface may also introduce the first user to a third user interface, which is used by third users, such as friends and family, to make monetary contributions to a user account set up by the first user for the benefit of a second user beneficiary or purchase investments that are added to the user account for the benefit of the second user beneficiary.

A practical example of the first user interface may involve a grandmother (first user) who uses the system to learn about various financial investments and innovative ways to engage her grandchild in the world of investing, and to contact a seller of one such financial investment with the intent to purchase such an investment for her granddaughter. The system would store information regarding the grandmother on the database and information regarding the contact made between the grandmother and the seller of the financial investment. This may occur either by linking the user to the financial institution, financial advisor, or broker or by acting as a proxy for these entities to facilitate purchase of an investment. The first user interface would also introduce the grandmother to the second user interface that her granddaughter could access to learn about money, finance, investing and the like.

The third step 106 in the system is to receive confirmation from the seller of financial investments of the first user purchase of a financial investment or monetary gift (hereinafter referred to generally as a gift). The third step also includes storing such information which includes the name of the beneficiary (second user recipient) of the gift within the database of the system in a user account. It should be noted that the system may allow for a first user to purchase a financial investment, give a monetary gift (e.g., personal check or cash) or make charitable donation to a charity designated by the first user. With regard to a non-investment monetary gift, it is anticipated that the first user may set up a user account in the second user recipient's name via the financial investment seller. The first user controls the user account and the investments therein. The first user may determine when to alter the investment, sell investments, invest dividends, invest monetary contributions made by third users, donate portions of the investment to charities, etc. If desired, the first user may allow the second user beneficiary to assert some level of control over the account or investment and assume some responsibilities regarding the investments. The first user may also configure the account to allow the second user beneficiary to make monetary donations to the non-investment account. For example, the second user beneficiary may wish to place a percentage of his/her allowance in this non-investment account to save for a trip abroad in junior high school or have first user purchase investments with the money.

In the example above, once the grandmother completes the purchase of the financial investment for her granddaughter, the system is notified of the purchase via a link between the seller of the financial investment and the system database or via the proxy server. The database receives the notice of purchase and stores the information therein. Alternatively, the grandmother may decide to purchase a monetary gift which would require the financial investment seller to create an account in the granddaughter's name and deposit the gift therein. The information regarding the creation of the account as well as the monetary gift are received and stored within the system database.

As described above, a first user, such as the grandmother, sets up the account. The first user typically controls the account and may or may not allow certain control by the second user beneficiary. Either the first user of the second user beneficiary or both may invite third users to also participate. Third users may be family or friends who are interested in purchasing financial investments or providing non-investment monetary gifts (e.g., personal check or cash) most likely to be used for purchase of financial investments for the benefit of the second user beneficiary. For example, when the grandmother elects to provide an investment to her granddaughter, the granddaughter's aunt may wish to also donate to the account. In this embodiment, the aunt would be provided with a third user interface that allows the aunt to either make a monetary gift that can be used to purchase additional shares of an investment in the second user beneficiary's account or directly add to that investment account by working with the designate financial institution and have them linked to the account for the benefit of the second user.

A separate, concurrent step 108 in the system is to provide a second user interface, as mentioned above. The second user interface is designed to provide educational and entertaining interactive tools and content to second user beneficiaries and non-beneficiaries, namely children, relating to money, finance, saving, spending, giving and investing. The second user interface would include interactive games, multi-user competitions, virtual worlds, social networking, child-generated content with colorful character, avatars, and storylines mixed in. The interface may also include stories and movie clips that simultaneously entertain and educate in the area of money, saving, investing and spending. It is envisioned that the second user interface would provide different levels of interaction for children depending on their age, ability and interest. The second user interface may have opportunities to create and manage their own investment portfolios, with faux currency but real-life publicly traded companies, and to participate in competitions directly related to those faux portfolios (e.g., build the largest “nest eggs” (portfolios) and beat the pros). Other games might include: Outsmart your parents and Invention Dimension, where children can launch their inventions on a virtual stock exchange. Virtual investments available on the second user interface may include publicly traded equities, bonds, real estate, commodities and more. It is noted that similar games, investment information/education, storylines, etc. may be also provided for use by the general public via fourth user interfaces.

In some embodiments, the second user interface would enable a child to inhabit a virtual world dominated by fascinating egg-laid animal investors and investment or investment-related professionals (e.g., mortgage lenders that hatch from eggs). These include but are not limited to risk-taking pterodactyls, constantly-changing chameleons, more financially cautious penguins, stubborn bullfrogs, octopuses with their “hands” in all kinds of investments and sneaky sea devil investors. The second user interface may also feature topical real-life daily market updates and events, all presented in an entertaining manner that's consistent with the rest of the second user interface and with a focus on what would most appeal to children (e.g., products like the latest video games and electronic gadgets that strongly appeal to children).

While the second user interface is designed to entertain, it will nonetheless offer insights, facts and developments (e.g., storylines and real-life financial market news) that will educate children about and immerse them in the world of finance and investing. For instance, a child interacting on the second user interface may learn the impact of an interest rate hike because the stocks in his or her faux portfolio may fall the day the rate hike is announced. The second user interface will explain that development in a child-friendly, age appropriate, engaging manner. Alternatively, an insider trading shark (part of a second user interface storyline) may get caught, and the child will learn about what constitutes an inside trade. The second user interface may also infuse interesting and fun science-based factoids relating to the featured animal avatars and characters and their natural habitats. It is also envisioned that the second user interface will be infused with entertaining but real-life scientific information about various real-life animals that hatch from eggs, their various related ecosystems and other related fascinating facts.

It is further envisioned that the second user interface may have information regarding charitable giving and thus the second user interface may have links to third party non-profit or charitable organizations. The charitable or non-profit links would provide children with information regarding their organization and ways to give or help. Regarding charitable giving, it is envisioned that the second user interface may also include a peer-to-peer advice area where other children may offer advice or provide comment on charitable gift giving.

The second user interface may also have varying levels of access with restricted access to those second users who have received investment gifts. The accessibility and detailed use of these limited access levels will be discussed in more detail below.

Once the system has received confirmation of the purchase of the gift by the first user as discussed above with respect to the third step 106, the system electronically notifies the second user recipient of the gift. The system will also send the second user a fun physical gift related to that initial investment. This identified as step 110. With notice of the gift, the system may also provide additional access to the second user recipient to otherwise restricted levels of the second user interface. The database would contact the second user recipient and provides him or her with a means for accessing otherwise restricted areas of the second user interface, such as a password. The second user recipient may also receive information relating to his or her investment that may be used in the second user interface. For example, a monetary value may be given to second user's avatar that is reflective of the financial investment received by the second user which enables second user to buy and enjoy certain things within a virtual world within the second user interface.

The second user may also be able to invest in the virtual world and observe the growth or decline of his or her virtual investment over time as he or she makes certain decisions regarding the virtual investment. In the example provided above, where a grandmother makes a purchase of a financial investment for her granddaughter, the granddaughter would be contacted via the system to let her know of the investment gift. This contact may be via a network such as the Internet, or may be by mail, such as a card. The contact may also include more details about the gift as well as a password or other instructions enabling the granddaughter to access otherwise restricted levels within the second user interface. The details regarding the gift may also enable the granddaughter to use an assigned monetary value of the gift within a virtual world so she can purchase or enjoy certain benefits that she would otherwise not have, i.e. use faux currency to spend as desired in the virtual world. The granddaughter may also use the monetary value of the gift to engage in virtual investing to learn how investments are made and grow over time. She may also use the monetary value or faux currency to play games on the second user interface.

It is envisioned that the games and investing may enable the user to further earn points or faux currency through effective investing or gaining knowledge about finance and investing. For example the granddaughter may receive an initial sum of faux currency with her grandmother's gift, but she may earn additional points or faux currency on the second user interface by choosing responsibly in her virtual investments or by playing games where she can successfully answer questions relating to finance or investing. It is envisioned that the points or faux currency may be converted into prizes for the second users.

Via the system where the gift provided to the second user is an electronically delivered monetary gift and an account has been created for such monetary gift, the system would then notify the second user beneficiary or his or her designated contact to inform them of the gift and account information. To encourage third users to give financial gifts for the second user beneficiary, the system may be used to contact third users regarding the account and inviting such third parties to make donations or purchase investments on behalf of the second user beneficiary. In the example, if a family friend gave a monetary gift to the second user beneficiary, the system would contact the second user and his/her designated contact and inform them of the gift.

Concurrently with the notification to second user recipient regarding the gift, the system provides a communication link between the second user recipient and the first and third user purchasers enabling the second user recipient and first and third user purchaser to communicate regarding the growth and management of the gift and any other topics of interest to the two parties. This is identified as step 112. In the example above, the granddaughter may be able to communicate with her grandmother and family friend via the second user interface to thank them for their gift and to tell them how she is using the gift within the virtual world on the second user interface. The granddaughter may also be able to communicate with her grandmother regarding her virtual investment experience or what's overall happening in her life.

There are a couple other independent steps or features that are provided through the provision of the second user interface. These include providing an interface between the second user and extended family and friends (third users) thereof regarding requests for purchase of one or more financial investments for second user, identified as step 114. In the example, the granddaughter may wish to contact her other grandparents, aunts and uncles to ask them to buy financial investments for her for a particular goal she is trying to reach, such as college tuition, a trip abroad, etc. She can use the second user interface to keep in touch with her relatives and friends to inform them where she is in reaching her goal and how the investments are performing as time passes. When any family or friends express an interest in purchasing such an investment for the granddaughter (second user beneficiary), they are connected to the system as a third user through an interface and provided with financial investment information and possible contacts to purchase such investments or provide monetary gifts for the benefit of the second user beneficiary, which is step 104.

As may be understood, third users typically do not set up the account for the benefit of the second user beneficiary. Instead, third users typically either purchase investments that are added to the user account set up by the first user or provide monetary gifts that can be used by the first or second user (depending on how the first user has set up control of the account) to make investments with the gifted money.

It is anticipated that with regard to providing an interface between second user and family and friends, the system database may enable a family member or friend to customize and print out or electronically send an invention-themed gift card from the system, and deliver it with a printed check or via an electronic system to deposit it in an account created for the second user by a seller of financial investments. In this way, the second user or his or her family may decide how the gift should be invested, rather than the gift giver.

Step 116 is the another concurrent step of providing within the second user interface an interface between the second user and third user family and friends thereof regarding the planning and execution of gift giving events. In the example, the granddaughter may contact her relatives to let them know about a birthday, first communion, bat mitzvah, confirmation or graduation celebration she will be having. It is important to note that it is envisioned that steps 112, 114 and 116 may also be conducted via the first user interface and would be more appropriate where the second users are young children, unable to communicate with family and friends themselves. It is envisioned that both the first and second user interfaces may have links to internet event invitations or other event communication means to inform family and friends of a gift giving event, such as a birthday, as well as event planning tools that may be utilized by both the second user and/or his or her family.

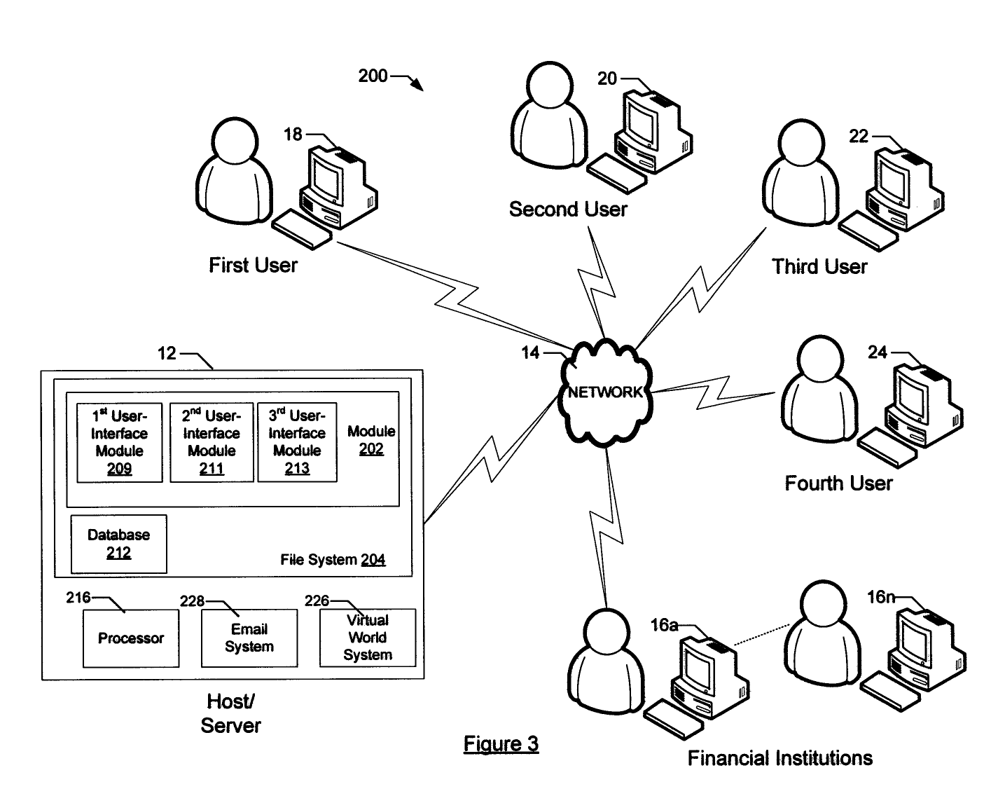

FIG. 3 is a block schematic diagram of another example of a system 200 of facilitating the creation of financial investment accounts and the purchase of financial investments in accordance with an embodiment of the present invention. The method 100 of FIG. 2 may be embodied in or performed by the system 200. The host/server 12 of the system 200 may include a module 202 for facilitating the creation of financial investment accounts and purchase of financial investments. The module 202 may be stored on a file system 204 of the host/server 12. The file server may be accessed via a network 14 via a computer system operated by a first user 18 or similar networked device, such as a personal digital assistant or the like. The exemplary computer system may be used by a first user 18, to access or enter a first user interface sub-module 209 as described herein. A second exemplary computer system may also be used by a second user 20 to access a second user interface sub-module 211 as described herein. A plurality of first 18 and second 20 users may each use a computer system to participate in the first 209 and second 211 user interface sub-modules as described herein. Third users 16 may also use like computer systems or other networked devices such as PDAs to access third interface sub-modules 213. The interface sub-modules are typically web pages stored on the server.

The module 202 of facilitating the creation of financial investment accounts and facilitating the purchase of financial investments may include a first user interface sub-module or component 209. The first user interface sub-module 209 may include financial investment information to enable the first user to learn about a variety of financial investments, and to contact via the system 200 a seller of financial investments. The financial investment information may include a link via a network, such as the Internet, to enable a first user 18 to contact a sales representative of the seller of financial investments. Alternatively, the financial investment information may provide contact information, such as a phone number or address, where the seller of financial investments may be reached. The financial investment information may also prompt the first user 18 to provide name and contact information which may be stored in the system 200 as well as forwarded to sellers of financial investments for their use.

The first user interface sub-module 209 may also include a means to communicate with a second user 20, potential beneficiary of the first user's purchase financial investment. This may be accomplished via a network link to an email system 228 or via a virtual world system 226 where the first 18 and second 20 users communicate via their respective avatars. The first user interface sub-module 209 may further include a means to communicate between the first user 18 and family and friends of the first and second users (i.e., third users 22). This may also be accomplished via a network link to an email system 228. Communication means to third users may include links via a network to a gift registry, or a calendar of gift giving events, or a site where prior gift giving events may be viewed.

The module 202 for facilitating the creation of financial investment accounts and facilitating the purchase of financial investments may include a second user interface sub-module or component 211. The second user interface sub-module 211 may generate and present a second graphic user interface (“GUI”) to the second user 20 to enable the second user to learn about money, saving, investing, spending, giving and the like. The second user interface sub-module 211 may include educational and entertaining interactive tools to learn about money, spending, saving and giving. The second user interface sub-module may include games relating to money and finance. The second user interface sub-module 211 may provide various levels of access to second users 20 depending on the value of or number of deposits into their real-life investment account. The second user interface sub-module 211 may include educational information relating to money, spending, savings, investing and giving. The second user interface sub-module may include a means for second users to participate in a virtual world system which may be accessed via a network, such as the Internet.

The second user interface sub-module may further include a means for second users 20 to communicate with other third users 22. Similar to the first user interface sub-module 209, the second user interface sub-module 211 may include a link via the system 200 for the second user 20 to communicate with existing first users 18 or other potential purchasers of financial investments (third users). The second user interface sub-module 211 may also include a communication link between the second user 20 and first users 18 or third users 22 to invite them to gift giving events, to present a gift registry of desired financial investment gifts and to share with first users or other family and friends the progress or status of existing financial investments. These may be accomplished through an email system, a gift registry, a shared calendar of gift giving events, social networking portals and interfaces, or a system for viewing prior gift giving events.

A database 212 within the system 200 would store all of the information discussed above relating to the various users. The database 212 could receive and store information regarding contact made between first users 18 and sellers of financial investments and any resulting financial investment accounts created and/or financial investments purchased. The database 212 could receive and store information regarding the identity of the second user 20 beneficiary of any financial investment. The database 212 could receive and store information regarding the interaction between a second user 20 and the educational and entertainment tools within the second user interface sub-module 213. The database 212 could store information regarding access and use of the system by third users 22 and/or interaction of third users with first and second users.

The computer system 206 may also include a processor 216. The module facilitating the creation of financial investment accounts and facilitating the purchase of financial investments may be accessed from the file system 204 and run on the processor 216.

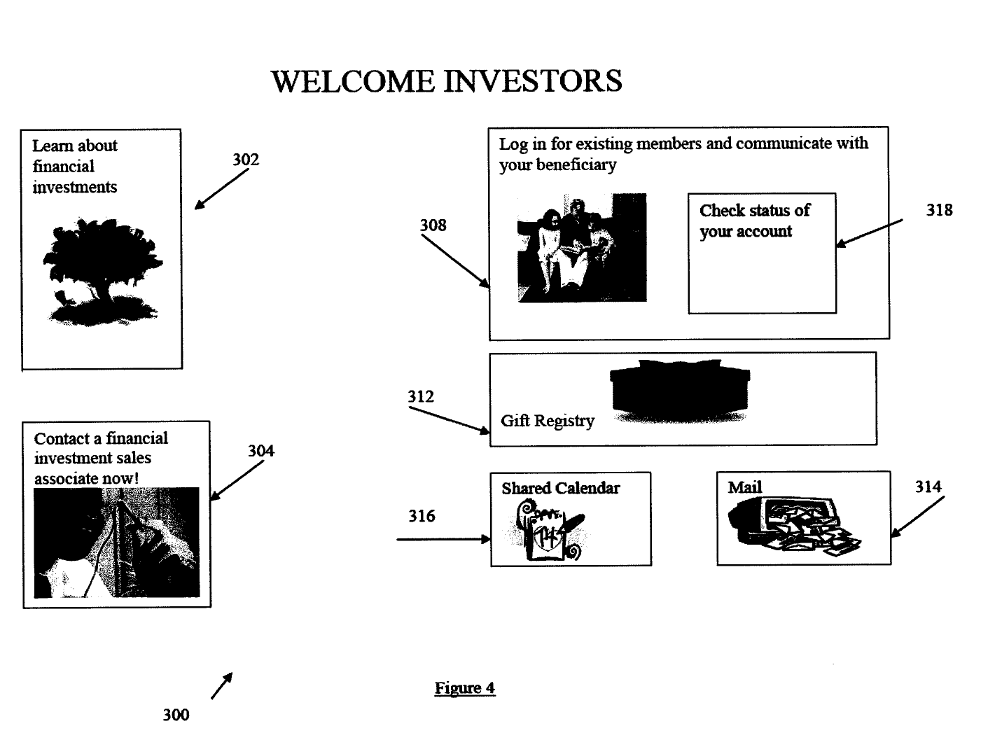

FIG. 4 is an example of a first user interface 300 for facilitating the creation of financial investment accounts and facilitating the purchase of financial investments in accordance with an embodiment of the present invention. The first interface 300 may include an educational section 302 that provides general information and advice on investing for and raising financially savvy children, as well as more detailed information on a variety of financial investments available through the first user interface. The first user interface 300 may also provide a link 304 via a network, such as the Internet, and phone number to directly contact a seller of financial investments detailed within the first user interface. The link 304 would send the seller of financial investments information regarding the user of the first user interface 300 which would be designed to prompt the seller of financial investments to contact the user and pursue a sale of such financial investments. The first user interface 300 may also include a section enabling the user to input information regarding the user and the identity of one or more beneficiaries of any financial investments the user may purchase. The first user interface may also include a communication section 306 that would first enable the first user to communicate with an existing or potential beneficiary of a financial investment made by the user, beneficiary communication section 308. The communication section 306 may further include a third party communication section 310 that would enable the first and/or second user to communicate with family and friends of an existing or potential beneficiary of a financial investment. Such a third party communication section 310 may include a gift registry 312, requesting financial investment gifts on behalf of the existing or potential beneficiary, an email site 314 for corresponding via email or other electronic methods with third parties, and a notice site 316 for providing notice to third parties of upcoming or past gift giving events. The first user interface 300 may further include a link to access financial investment account information 318.

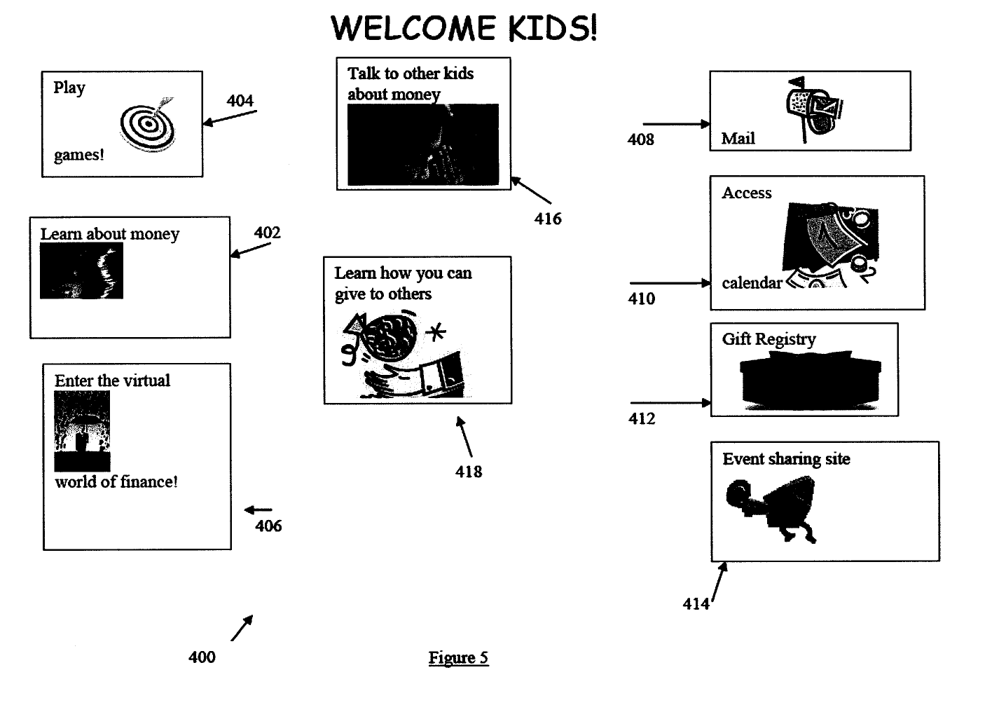

FIG. 5 is an example of a second user interface 400 for facilitating the creation of financial investment accounts, facilitating the purchase of financial investments and providing a link to the third party beneficiary of the financial investment in accordance with an embodiment of the present invention. It is appreciated that the target audience for the second user interface is children. It is further appreciated that the first user interface is adults, and in particular adults who are interested in buying financial investments on behalf of children, the second users. The second user interface 400 may include an educational section 402 that provides general information on money, saving, spending, giving and investing, all presented in a way that entertains and engages the children. The second user interface 400 may provide interactive, age appropriate games 404 relating to money and finance. The second user interface 400 may also provide a link to one or more virtual reality systems 406 that enable the second user to create an avatar and experience life within the investment-themed virtual world. The virtual reality systems 406 and other games 404 may have certain levels which may only be reached by second users who are also beneficiaries of financial investments purchased through the system. Thus the second user beneficiary may use faux currency linked to the amount invested by one or more first users on behalf of the second user beneficiary. The faux currency may enable the second user beneficiary to purchase items within the virtual world 406, play certain games 404 or invest within the virtual world or other games. A purpose of this interface is to provide an engaging gift for the second user.

The second user interface 400 may also include a link 408 to an email or other electronic communications system 408 that would enable the second user to communicate with first and third users regarding second user beneficiary's investment, as well as update first and third users on second user's plans for spending the investment, requests for future gifts and giving notice of upcoming gift giving events. It should be noted that the second user may also communicate with the first user via avatars in a virtual world system. The second user interface 400 may further include a third party communication link 410 that would enable the second user to communicate with other family and friends regarding requests for financial investments via a link to a gift registry 412, a shared calendar 410 and a link 414 to a site where past gift giving events may be shared or viewed. The second user interface may also include a separate means for second users to engage in peer-to-peer communications 416 regarding money, saving, finance, spending and giving the like, and fun events and activities in interface 400. The second user interface 400 may also include a link to information on a variety of charitable and non-profit organizations 418 where children may wish to donate some of their investments.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

The above description provides an example of the operation of the systems and methods of the present invention. Provided in the attached appendix is added general information and examples illustrating the invention in greater detail.

### APPENDIX

### 1. Introduction

The present invention provides a system that enables friends and family to give financial gifts to children in a completely new way that engages those children (the giftees), while appealing to the children's parents, grandparents and other gift-givers.

The system is designed around two core sections. The first is a kid-centric entertaining investment-themed web experience that is accessible to all children; those with investments will have access to an even more robust online and offline experience (e.g., more faux currency with which to play games). The second section targets adults. This section provides gifters (including parents and grandparents) with a step-by-step guide for purchasing mutual fund investments and/or making cash contributions, contact information, including web links, to connect with financial firms selling investments, and tools for staying connected to the giftees (and visa versa). This section also gives parents and grandparents the tools to steer friends and family toward giving their kid(s) financial gifts vs. other kinds of presents (e.g., toys, savings bonds, personal checks), and provides tips and tools for engaging kids in investing and planning kids/family parties.

While the system may have several categories of partnerships (e.g., promotional, content, distribution), the primary partners may be financial firms. These designated firms will promote the system to their clients and prospects, advise them on which investments to buy, and directly sell them the investments. The present invention provides the system to facilitate this; we will neither advise consumers on what to buy nor sell them any investments. For these financial firms, the system will function as an additional marketing arm, steering new prospects to their firms and enticing current clients to buy mutual funds.

### 2. Overview

The present invention is a first-of-its-kind financial gift-giving venture that truly delights kids, while appealing to adults looking to give a meaningful, long-term financial gift that enlightens and entertains them and fosters ongoing connections. It's also designed to help parents raise investment savvy, socially minded children and better plan and execute gift-giving events for children.

The system may be a combination of real-life financial investments purchased from financial firm partners and an exciting, ongoing gift experience for kids. In contrast to current financial options, the system seeks to make the child's experience as paramount to its success as the overall performance of the funds our financial partners sell under the system.

The system and its financial partners will market investments to adults interested in purchasing or adding to a child's 529 education savings account and for important gift-giving occasions for kids: milestones (e.g., births, bar and bat mitzvahs, christenings, birthdays, confirmations) and major annual holidays. The system may directly target parents and grandparents, while offering strong viral components to pull in extended family and family friends who celebrate with those kids on those occasions.

The system addresses at least the currently unmet needs of the three core constituents in the kids' gift-giving marketplace:
It may enable friends and family to give kids a financial gift that truly excites them. From the very start of the experience—when the child receives a physical nest egg that's gift-wrapped—to the ongoing experience of the website. This contrasts to today's sterile experience that comes with standard savings bonds, personal checks, stocks or mutual funds.
Gives gift-givers a way to satisfy both the child and the parents, while fostering a long-term connection with the gift recipient through interactive tools.
Appeals to parents and grandparents looking to build their kids' financial security, while teaching them about investing in an engaging manner.

### 3. Main Consumer Components

The system may offer two distinct consumer experiences, one for kids (giftees) and one for adults (parents, grandparents and other adults interested in giving or who've already given a gift). The main components are as follows:

### Kids Gift

Initial gift:
Financial gift: Shares in a publicly traded investment(s) sold by a select group of financial partners. Through marketing efforts and incentives built into the website, adults will be encouraged to continually add to the child's account once it is set up.
Physical gift: A collectible faux animal “nest egg” filled with a fun investment certificate, egg-laid stuffed animal or other appealing child's collectible, and a secret password to website. The system will mail this nest egg to each child gift recipient right after the financial gift is bought in his/her name.

Ongoing gift experience: Website:
Captivates kids in the new “magical world of finance. A fuller description is below in section #4.

### Adult Experience

The adults' section of the website will primarily explain how the system works, including its value proposition, and provide a means for connecting adults to participating financial firms to learn about and/or buy a financial investment, or making cash contributions. It will also provide compelling content and tools for parents to plan and execute fabulous kid- and family-oriented gift-giving events and/or to celebrate those occasions.

### 4. Website

### Consumer Experience

The website may be divided into at least two main areas: one for kids and one for adults interesting in learning more about the system and/or looking to purchase an investment.

### A) Interface for Gift Receivers: Kids Experience

The system may provide an imaginative destination website, a digital fantasy-land that's all about fun, adventure, discovery and empowerment, cleverly veiling its educational aspects.

The website may offer the kind of immersive content and functionality today's kids crave: interactive games and competitions, virtual worlds, social networking, kid-generated content with colorful characters, avatars, and storylines mixed in. It's all themed around investing and all executed from a “kids rule” point-of-view. It also will encourage and enable kids to create and manage their own investment portfolio, with faux currency but real-life publicly traded companies, and to participate in competitions directly related to those faux portfolios (e.g., build the largest “nest eggs” (portfolios) and beat the pros). Other games might include: Outsmart your parents and Invention Dimension, where kids can launch their inventions on the site's faux stock exchange. Investments include publicly traded equities, bonds, real estate, commodities and more.

Kids may inhabit a world dominated by fascinating themed animal investors and other stock market pros that hatch from eggs, which ties into the name of the company. These include but are not limited to risk-taking pterodactyls, constantly-changing chameleons, more financially cautious penguins, stubborn bullfrogs, octopuses with their “hands” in all kinds of investments and sneaky seadevil investors.

The kids section will also feature topical real-life daily market updates and events, all presented in an entertaining manner that's consistent with the rest of the kids section and with a focus on what would most appeal to kids (e.g., an analysis of the maker of popular kids video games).

While the kids section is designed primarily to entertain kids, it will nonetheless offer insights, facts and developments, including ongoing storylines, that will teach kids about finance and investing. For instance, they may learn the impact of an interest rate hike because the stocks in their faux portfolio may fall the day the rate hike is announced. The system may explain that development in a kid-friendly, engaging manner. Or, an insider trading shark (part of a storyline) may get caught, and kids will learn about what constitutes an inside trade.

Any child can sign up to access the kids' portion of the website. However, only kids with investments will be able to access certain exclusive kids sections of the website; these kids will also be awarded bonus points for playing games, setting up their faux portfolios and more.

### B) Interface for Adults: Parents/Grandparents and Other Gifters

An adults' section of the website will:
Communicate the names of participating financial partners and directly connect adults to those financial partners (via web links and phone contact information).
Encourage them to sign up to be contacted by specific financial partners or receive information from those partners.
Give them a guided tour of or connect them to the kids' portion of the website so they can see the kids' website experience for themselves.

### a) Parents/Grandparents

Detail the “nuts and bolts” of the system, specifically 1) step-by-step instructions on how to purchase investments and set up an account; 2) the reasons for buying an investment (e.g. the importance of savings for a child's future); 3) instructions and tools for to setting up a child's gift registry on the site; 4) e-tools for parents to communicate with friends and family about their child's account; and 5) tips and tools for planning and executing gift-giving events (this will include content provided by the system and peer-to-peer advise).

This gift registry will likely include the following:
A place for the child to write a personal message (e.g., I am saving for the chance to study abroad when I'm in high school, save for my college education . . . )
The name(s) of the investment(s) his/her parents or other relatives have purchased for him/her.
A section for the family to designate a charity that they'll be donating to if they so choose. A place for the child to communicate via his selected avatar or other electronic communications tools.

E-communications tools will likely include the following:
E-gift registries, save-the-date e-notices, personalized thank-you e-cards, and birthday reminders to friends/family.

Tips and tools for planning fabulous themed kids/family parties will likely include:
Budgeting guidelines, party checklist, surprising party ideas, themed menus, organizational tips
Peer-to-peer advice, content partnerships and more
Viral e-communications tools: themed e-vites, save-the-dates and thank-yous

Tips and tools for engaging kids in investing and teaching “giving back” will likely include:
Peer-to-peer advice and content partnerships
Tools for charitable gift-giving
   b) Other Gifters (extended friends and family)
Detail the “nuts and bolts” of the system, specifically 1) step-by-step instructions on how to purchase investments or give another monetary gift on behalf of the child with a Ballooning Nest Eggs account; 2) the reasons for buying an investment (e.g. the importance of savings for a child's future); and 3) printable and e-versions of gift cards.
The gift cards may have these features or options:
   An assortment of kid-friendly Ballooning Nest Egg-themed designs for printable gift cards, which can feature the giftee's designated avatar. The gifter can customize his/her message to the child and can print out the card. The card will tell the giftee that 1) the gifter has purchased shares in an investment for him/her; or 2) the enclosed check or cash should be deposited in his/her account.
   E-card that looks just like the printed card. The e-card will most likely be used for people who've bought shares in an investment.

### 5. Step-by-Step

### How it Works

The way children interact with the website and adults learn about the system, tell friends and family about it, and purchase the funds will vary on a case-by-case basis. The example below illustrates one possible scenario:
Marketing and “word-of-mouth” recommendations and referrals steer parents and/or grandparents to the adult section of the website to register 10-year-old Sam.
   Sam's parents set up a gift registry and import email addresses of friends and family.
   Sam and his parents have decided to donate 10% of his financial gifts to one of Sam's favorite charities, which his gift registry and personal pages detail.
   Sam picks his avatar: spiny anteater regulator, earning points for catching insider trading sharks
   Mom starts planning Sam's upcoming elementary school graduation party with party planning tools and content, and seeks input from other moms
This section of the site drives them to financial partners to learn about the best investments for Sam and to buy the initial investment. This triggers the system to send Sam a fabulous “welcome kit” that consists of the nest egg, starter faux “currency” and more.
Sam signs up to join the system, using his secret password, and dives into the virtual world. He pulls in his friends for competitions and other fun. He also competes against, forms teams with, and/or interacts with other kids who he's never met on the site.
   They build portfolios and compete vs. each other and other teams
      Goal: To build the largest “nest eggs” and even beat the pros
Sam's parents and Sam e-mail themed “save the date” notices to family and friends regarding Sam's upcoming party and Sam's gift registry.
   The e-notice directs recipients to the adult portion of the website, encouraging them to either buy shares of an investment from a financial partner or give Sam a personal check, 90% of which his parents will deposit in Sam's investment account (the remaining 10% goes to Sam's designated charity).
   As a result, grandma and grandpa and uncle David add directly to Sam's investment account, prompting Sam to receive more “faux” currency or other gift eggs. Sam's extended friends and family give checks with gift cards (printed from the website), which mom deposits into Sam's account.
The immersion continues after the event.
   Uncle David uploads his photo and adds a personal message to Sam's “Flock of Fans” section. His mom adds everyone who gave checks to this section, fostering ongoing e-connections.
   Sam sends e-thank-you notes with digital photos of his graduation party.
   Each real-life addition to Sam's brokerage account earns him more faux “currency,” so he pushes his parents/grandparents to invest more.
Sam's friends tell their parents, grandparents and aunts/uncles about the system, driving them to the website.
Sam adds his upcoming and ongoing life events into his calendar
   Before gift-giving events, parents and Sam send e-cards to friends and family, linking them to website and Sam's gift registry
   The system sends everyone in Sam's registry automatic e-birthday reminders, spurring traffic to website
   Automatic reminders of his friends' and family's birthdays prompt Sam to send them e-birthday cards
All the adults who contributed to Sam's account (buy either directly purchasing shares through participating financial firms, by writing a check that they've designated to be deposited into an account or by using a credit card to give him cash via the system), receive fun email reminders about Sam's upcoming birthday and other special occasions. These emails will also have links that directly connect those adults to the adult section of the system.

### 6. Today's Consumer Options

Consumer options for kids' financial gifts are typically one dimensional—designed almost exclusively for the parents and grandparents, with only secondary thought, at best, given to the recipients—the kids—beyond planning for their financial security.

When given to children as gifts, today's typical stocks, bonds, checks and mutual funds typically elicit a ho-hum reaction from the recipients. They come in a generic, sterile package, devoid of any kind of experience, gift- and kid-friendly “packaging,” and personalization.

Even the most advanced attempts to reach out to kids miss the mark. They're all one-dimensional with dated executions, and completely overlook today's most popular web 2.0 experiences (e.g., user-generated content, virtual worlds, social networking). None regularly update content or offer other incentives for kids to come back day after day. All are geared towards educating vs. entertaining kids.

### 7. Main Business Partnership Components

Revenue generation will be from financial firm partners and website sponsors.

### Financial Firms

Company will partner with a select group of financial institutions that include but are not limited to brokerage firms, asset management firms, consumer banks, wealth management firms or divisions of larger financial companies, and other diversified financial institutions.

The Company could but likely may not sell funds itself, but rather may drive prospects to participating financial firms, who will advise them on and directly sell them mutual funds under the Company's umbrella.

Specific marketing support includes the following:
Extensive “viral” components will pull in a large network of friends and family, introducing them to the system and connecting them to our financial partners. These components mostly will be easy-to-use internet-based marketing tools.
   Parents and kids (giftees): E-gift registries, save-the-date e-notices, personalized thank-you e-cards, and birthday reminders to friends/family.
Prominent exposure in the adult's section of the website, with easy-to-use tools and features that directly connect adults to those financial partners
   This will include logos that link into an exclusive page for each financial partner, contact information, possible rich media ads and more.
   Company may tier the partnerships so that firms that give us a larger financial commitment will receive greater promotional exposure on the website.
Built-in incentives that drive kids to “nag” their parents/grandparents to open and add to the investment accounts.
   Kids earn faux “currency” when a brokerage account is set up and for each new transaction.
   Only kids with accounts can access the site's coolest parts.
Promotional partnerships that may range from kids play spaces to AARP (American Association of Retired Persons).
Advanced search and other marketing outreach.

The system may spur initial and repeat purchases of investments as gifts for kids. Additional benefits include:
Steering current and new prospects to our financial partners
Increasing the incidence of and occasions for buying financial investments
Helping our partners tap into whole new prospect base beyond parents and grandparents
Enabling our partners to capture the large pool of money that otherwise goes into bank accounts, gift certificates, savings bonds, electronics and other pricey toys/games.

### Sponsors

The Company may sell sponsorships to kids-oriented advertisers on the kids section of the website.
Sponsors will be weaved in throughout the kids' area, including games, storylines and more.

Additional partners include the following:

### Promotional Partners

The Company may attempt to secure promotional partnerships with relevant companies, organizations and media. The goal of these partnerships will be promote and drive traffic to the site and/or offer an implied endorsement, giving further credibility to the site.

### Content Partners

The Company may attempt to secure partnerships with providers of relevant content. These content providers may include companies that track and report investments, report market updates, help adults plan kids parties and more.

### Distribution Partners

The Company may also secure partnerships with other digital properties that will steer traffic to the site.

What is claimed is:

1. A system for facilitating the purchase of financial investments on behalf of a beneficiary and providing information regarding same comprising:
a processor;
at least one database comprising information regarding one or more financial investments;
at least one first user interface communicating with said processor to provide information to a first user regarding one or more financial investments, to facilitate the purchase by the first user of one or more financial investments, and to enable the first user to designate a second user beneficiary of the financial investment; and
at least one second user interface communicating with said processor to provide interactive tools to the second user beneficiary regarding the one or more financial investments purchased by the first user.

2. The system of claim 1 further comprising a link between said database and one or more computer-based systems affiliated with one or more sellers of financial investments, wherein said link is used to allow the first user to purchase one or more financial investments from the seller, and wherein when the first user purchases a financial investment from the seller to benefit a second user beneficiary, confirmation of the purchase is sent via said link from said computer based system of the seller to said processor.

3. The system of claim 2, wherein when said processor receives the confirmation, said processor sends notice of the confirmation to the second user beneficiary via said second user interface.

4. The system of claim 1, wherein when the first user purchases a financial investment and designates a second user beneficiary, said processor sends notice to the second user beneficiary via said second user interface.

5. The system of claim 4, wherein said second user interface allows the second user beneficiary to access otherwise restricted levels in said second user interface.

6. The system of claim 4, wherein said processor via said second user interface enables the second user beneficiary to engage in educational and entertaining interactive tools within said second user interface.

7. The system of claim 4 comprising a fourth user interface that enables a user of the system to engage in educational and entertaining interactive tools within said second user interface.

8. The system of claim 1, wherein said first user interface is further adapted to allow the first or second user to notify third users of events related to the second user beneficiary.

9. The system of claim 1, wherein said first user interface is adapted to allow first or second users to plan events and send invitations to third users regarding a second user beneficiary.

10. The system of claim 1, wherein said first user interface is further adapted to facilitate purchase of investments by the third users for the benefit of the second user beneficiary.

11. A computer implemented method for facilitating the purchase of financial investments on behalf of a beneficiary and providing information regarding same comprising:
providing at least one database containing information regarding one or more financial investments;
providing at least one first user interface to enable a first user to access information regarding one or more financial investments, to facilitate the purchase by the first and third users of one or more financial investments, and to enable the first user to designate a second user beneficiary of the financial investment; and
providing at least one second user interface to enable access by the second user beneficiary to interactive tools relating to financial investments.

12. The computer implemented method of claim 11 further comprising providing a link between the database and one or more computer based systems affiliated with one or more sellers of financial investments, wherein the link is used to allow first and third users to purchase one or more financial investments from the seller, and wherein when the first and third users purchases a financial investment from the seller to benefit a second user beneficiary, said method further comprises sending confirmation of the purchase via the link from the computer based system of the seller to the database.

13. The computer implemented method of claim 12, wherein when the database receives the confirmation, said method further comprises sending notice of the confirmation to the second user beneficiary.

14. The computer implemented method of claim 10, wherein when the first user purchases a financial investment and designates a second user as a beneficiary, said method further comprises sending notice to the second user beneficiary.

15. The computer implemented method of claim 14 further comprises allowing the second user beneficiary to access otherwise restricted levels in the second user interface.

16. The computer implemented method of claim 11 further comprising enabling a user to engage in educational and entertaining interactive tools.

17. The computer implemented method of claim 11 further comprising enabling the first user to notify third users of events related to the second user beneficiary.

18. The computer implemented method of claim 11 further comprising enabling the first or second user to plan events and send invitations to third users regarding a second user beneficiary.

19. The computer implemented method of claim 11 further comprising facilitating purchase of investment by the third users designating the second user beneficiary.

20. A system for facilitating the purchase of financial investments on behalf of a beneficiary and providing information regarding same comprising:
a processor;
at least one database comprising information regarding one or more financial investments;
at least one first user interface controlled by said processor to provide information to a first user regarding one or more financial investments, to facilitate the purchase by the first user of one or more financial investments, and to enable the first user to designate a second user beneficiary of the financial investment;
at least one second user interface controlled by said processor to provide interactive tools to the second user beneficiary regarding the one or more financial investments purchased by the first user; and
a link between said database and one or more computer based systems affiliated with one or more sellers of financial investments, wherein said link is used to allow the first user to purchase one or more financial investments from the seller, and wherein when said first user purchases a financial investment from the seller to benefit a second user beneficiary, confirmation of the purchase is sent via said link from said computer based system of the seller to said processor.
